(19) United States
(12) Patent Application Publication
(10) Pub. No.: US 2008/0252856 A1
(43) Pub. Date: Oct. 16, 2008

(54) WIRELESS PRESENTATION MULTI-PROPORTION SCALING METHOD

(75) Inventor: Chun-Jung Hsiao, Chung Ho (TW)

Correspondence Address: RAYTAC CORP., P.O. BOX 108-00403, TAIPEI, TW

(73) Assignee: RAYTAC CORP., Chung Ho (TW)

(21) Appl. No.: 11/734,790

(22) Filed: Apr. 13, 2007

(51) Int. Cl. G03B 21/00

(52) U.S. Cl. 353/40; 715/730

(57) ABSTRACT

A wireless presentation multi-proportion scaling method in which the user operates a wireless remote control device to transmit a multi-proportion scale signal through a transmitter side wireless transmission interface to a receiver side wireless transmission interface for converting into a predetermined format scaling instruction for output to a presentation player for enabling a scaling application program in the presentation player to make a real time computing on the received scaling instruction and to further adjust the size of the images of electronic slides to the full screen size for display on a display screen.

### BACKGROUND OF THE INVENTION

1. Field of the Invention

The present invention relates to wireless presentation and more particularly, to a wireless presentation multi-proportion scaling method.

2. Description of the Related Art

Following fast development of image projectors and related application programs, stationary projector systems are intensively used in theaters, meeting halls, activity centers and many other big places for film or image slide projection during a presentation or meeting. Further, following fast development of computer and its application, a projector may be used with a computer to project the images of electronic slides instead of the early application of projecting the images of real slides. Because the preparation of electronic presentation files is easy, people start to use projectors intensively.

Further, following continuous world population growth, available space is gradually reduced. In consequence, people have less space for living, working or making recreational activities. Therefore, office spaces, meeting spaces and other public spaces suitable for making presentation are commonly small and not suitable for application of a stationary projector. Nowadays, many mobile image projectors have been developed for home theater and presentation applications.

A mobile image projector system can conveniently and quickly be set up in a meeting room or classroom for making a presentation. After the presentation, the mobile image projector system can be quickly taken away from the meeting room or classroom. Further, multiple meeting can use a common single mobile image projector to save the cost. Further, an image projector can also be installed in a non-formal place such as a restaurant, lounge bar, coffee shop or plaza. By means of using a small round table or tea table as a platform, a mobile image projector can quickly be installed in a hall or place for making a product presentation, business presentation or seminar announce. A mobile image projector can also be used in a wedding hall or ceremonial hall during a wedding or memorial activity.

Further, a mobile image projector may provide auto focus and auto keystone correction functions to enhance ease of use. However, when using an image projector to make a presentation, the user may need to move the image projector or the computer to make a control (for example, the operation control for screen size scaling, last electronic slide or next electronic slide). It wastes much time in making such controls. Further, when making a control, the presentation or meeting may be interrupted.

Therefore, it is desirable to provide a presentation system that eliminates the aforesaid problem.

### SUMMARY OF THE INVENTION

The present invention has been accomplished under the circumstances in view. According to one aspect of the present invention, the wireless presentation multi-proportion scaling method is used in a wireless presentation system, which comprises a wireless remote control device, which has a transmitter side wireless transmission interface and is operable by a user to transmit a multi-proportion scale signal through the transmitter side wireless transmission interface, a receiver side wireless transmission interface, which receives the multi-proportion scale signal from the wireless remote control device and converts the multi-proportion scale signal into a predetermined format scaling instruction for output to a presentation player, which has installed therein a scaling application program. When the user operates the wireless remote control device to transmit a multi-proportion scale signal through the transmitter side wireless transmission interface to the receiver side wireless transmission interface, the receiver side wireless transmission interface receives the multi-proportion scale signal from the wireless remote control device and converts the multi-proportion scale signal into a predetermined format scaling instruction for output to the presentation player for enabling the scaling application program of the presentation player to make a real time computing on the received scaling instruction and to further adjust the size of the image projection of electronic slides to full screen size for display on the display screen. Therefore, the user can multi-proportionally alter the scale of the presentation image to the full screen size or return to the original scale by the wireless remote control device

### BRIEF DESCRIPTION OF THE DRAWINGS

FIG. 1 is a system block diagram of a wireless presentation system according to the present invention.

FIG. 2 is an operation flow chart of the present invention.

### DETAILED DESCRIPTION OF THE PREFERRED EMBODIMENT

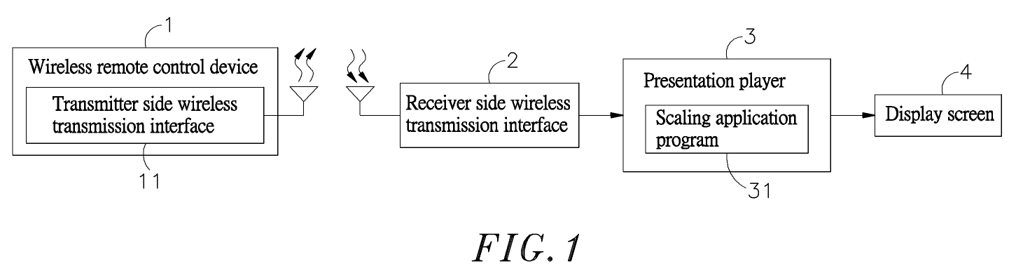

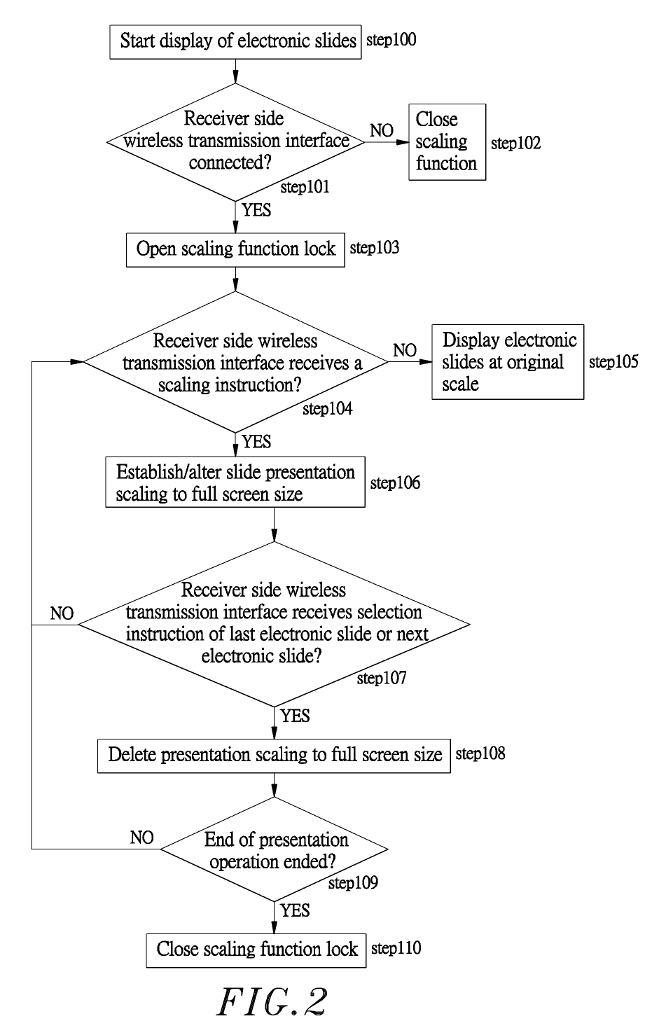

Referring to FIGS. 1 and 2, a wireless presentation system is shown comprised of a wireless remote control device 1, a receiver side wireless transmission interface 2 and a presentation player 3.

The wireless remote control device 1 has a transmitter side wireless transmission interface 11, and is operable by a user to transmit a multi-proportion scale signal through the transmitter side wireless transmission interface 11.

The receiver side wireless transmission interface 2 is adapted to receive the multi-proportion scale signal from the wireless remote control device 1, and converts the multi-proportion scale signal into a predetermined format scaling instruction for output to the presentation player 3.

The presentation player 3 comprises a scaling application program 31. Upon receipt of the scaling instruction from the receiver side wireless transmission interface 2 by the presentation player 3, the scaling application program 31 of the presentation player 3 makes a real time computing on the received scaling instruction for scaling the image projection of electronic slides to the full screen size for display on a display screen 4.

When the scaling application program 31 of the presentation player 3 is started during the use of the wireless presentation system, it runs subjects to the following steps:
(100) Start display of electronic slides;
(101) Check whether the receiver side wireless transmission interface 2 is connected or not, and then proceed to step (103) if positive, or step (102) if negative;
(102) Close scaling function;
(103) Open scaling function lock;
(104) Check whether or not the receiver side wireless transmission interface 2 receives a scaling instruction, and then proceed to step (106) if positive, or step (105) if negative;
(105) Display the electronic slides at the original scale;
(106) Establish or alter the slide presentation scaling to full screen size;
(107) Check whether or not the receiver side wireless transmission interface 2 receives a selection instruction of last electronic slide or next electronic slide, and then proceed to step (108) if positive, or return to step (104) if negative;
(108) Delete the presentation scaling to full screen size;
(109) Check whether the presentation operation has been ended or not, and then proceed to step (110) if the presentation operation has been ended, or return to step (104) if the presentation operation has not been ended.
(110) Close scaling function lock.

Referring to FIG. 1 again, in actual practice of the wireless presentation system, the receiver side wireless transmission interface 2 has a connection port electrically connected to the presentation player 3, and the scaling application program 31 is installed in the presentation player 3. The presentation player 3 can be an image projector or a computer having an image projector connected thereto. When the user operates the wireless remote control device 1 to transmit a multi-proportion scale signal through the transmitter side wireless transmission interface 11 to the receiver side wireless transmission interface 2, the receiver side wireless transmission interface 2 receives the multi-proportion scale signal from the wireless remote control device 1, and converts the multi-proportion scale signal into a predetermined format scaling instruction for output to the presentation player 3 for enabling the scaling application program 31 of the presentation player 3 to make a real time computing on the received scaling instruction and to further adjust the scale of the image projection of the electronic slides to the full screen size for display on the display screen 4.

The connection port of the receiver side wireless transmission interface 2 can be a USB, RJ45 or IEEE1394 connector connectable the connection interface at the image projector or computer, i.e., the presentation player 3. Further, the transmitter side wireless transmission interface 11 and the receiver side wireless transmission interface 2 can be of IEEE802.11 (Bluetooth, HomeRF) wireless standard.

The presentations to be displayed can be electronic projection films made by a computer program (for example, PowerPoint, Word) or electronic image presentation slides obtained through a digital camera or digital video camera that can be stored in a hard disk in a computer, a mobile floppy disk drive, a CD, a mobile memory stick, a memory card or any of a variety of other data storage means. When the prepared data storage device is connected to the computer or image projector, the invention can then be used to project the images of the electronic slides on the prepared display screen at one of a series of preset scales subject to the size of the display screen.

At this time, the connection port of the receiver side wireless transmission interface 2 is connected to the connection interface of the presentation player 3, and then the user can operate the wireless remote control device 1 to transmit a scale signal to the presentation player 3 through the receiver side wireless transmission interface 2 without moving the presentation player 3 for enabling the presentation player 3 to adjust the scale of the images of the electronic slides to the full screen size. If the user is customized to move all around and to interact with audiences, the user can move the wireless presentation system in the presentation place freely.

By means of the wireless remote control device 1 of the present invention, the user can control the operation functions of full screen scaling, last electronic slide, next electronic slide, etc. without moving to the presentation player 3 when driving the presentation player 3 to display presentations. Therefore, when using the present invention, the user needs not to move between the location near the display screen and the location near the presentation player, avoiding interruption of meeting or explanation due to movement of the user. Further, the user can select displayed or not displayed presentations, or scale up or down the size of presentations to match with the content of the speech during the explanation or meeting, so that audiences can understand the explanation and involve in the topic.

Further, it is the market trend toward light, thin, short and small electronic devices. Therefore, an electronic device generally has many different types of connection ports for the connection of different peripheral apparatus. The invention has the connection port of the receiver side wireless transmission interface 2 be connected to the connection interface of the presentation player 3 and installs the scaling application program 31 in the presentation player 3 so that the user can use the wireless remote control device 1 to control the presentation player 3. The wireless presentation system according to the present invention is highly mobile for convenient use in different places, and the user can hold a high quality explanation meeting or explanation without spending much time in presentation test.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless presentation multi-proportion scaling method of using a wireless remote control device to control transmission of a scaling signal from a transmitter side wireless transmission interface to a receiver side wireless transmission interface for real time computing by a scaling application program for displaying electronic slides at the full screen size through a presentation player subject to the steps of:
(a) Start display of electronic slides;
(b) Check whether the receiver side wireless transmission interface is connected or not, and then proceed to step (d) if positive, or step (c) if negative;
(c) Close scaling function;
(d) Open scaling function lock;
(e) Check whether or not the receiver side wireless transmission interface receives a scaling instruction, and then proceed to step (g) if positive, or step (f) if negative;
(f) Display electronic slides at the original scale;
(g) Establish/alter slide presentation scaling to the full screen size;
(h) Check whether or not the receiver side wireless transmission interface receives a selection instruction of last electronic slide or next electronic slide, and then proceed to step (i) if positive, or return to step (e) if negative;
(i) Delete presentation scaling to full screen size;
(j) Check whether the presentation operation has been ended or not, and then proceed to step (k) if the presentation operation has been ended, or return to step (e) if the presentation operation has not been ended; and
(k) Close scaling function lock.

2. The wireless presentation multi-proportion scaling method as claimed in claim 1, wherein said scaling application program is installed in an image projector of said presentation player that displays the images of electronic slides.

3. The wireless presentation multi-proportion scaling method as claimed in claim 1, wherein said presentation player is a computer system.

4. The wireless presentation multi-proportion scaling method as claimed in claim 1, wherein said receiver side wireless transmission interface has a connection port electrically to a connection interface of said presentation player.

5. The wireless presentation multi-proportion scaling method as claimed in claim 4, wherein the connection port of said receiver side wireless transmission interface is selected from of one USB, RJ45, and IEEE1394 connectors.

6. The wireless presentation multi-proportion scaling method as claimed in claim 1, wherein said transmitter side wireless transmission interface and said receiver side wireless transmission interface are made subject to one of IEEE802.11, infrared and laser wireless standards.
